(19) United States
(12) Patent Application Publication
(10) Pub. No.: US 2011/0156371 A1
(43) Pub. Date: Jun. 30, 2011

(54) Fifth wheel locking pin

(76) Inventor: Barry A. Smith, North East, MD (US)

(21) Appl. No.: 12/928,378

(22) Filed: Dec. 10, 2010

Related U.S. Application Data
(60) Provisional application No. 61/283,937, filed on Dec. 10, 2009.

(51) Int. Cl. B60D 1/28

(52) U.S. Cl. 280/507

(57) ABSTRACT

The Fifth Wheel Locking Pin is a pin fitted with a lock, providing security for a trailer. The device consists of a hardened steel bar one-half inch in diameter, and approximately sixteen to twenty inches in length. The proximal end of the bar is a T-shaped handle made from the same stock. The distal end of the bar is fitted with a lock. The end of the bar is machined to fit the lock, and the bar is grooved, enabling the lock to mate with the bar through pins that extend from the lock into the grooves. The lock is mechanically operated by the turn of a key, extending or retracting the pins.

### CLAIM OF PRIORITY

This patent application claims priority under 35 USC 119 (e) (1) from U.S. Provisional Patent Application Ser. No. 61/283,937 filed Dec. 10, 2009, of common inventorship herewith entitled, “Fifth Wheel Locking Pin.”

### FIELD OF THE INVENTION

The present invention pertains to the field of anti-theft mechanisms, and more specifically to the field of automotive anti-theft mechanisms.

### BACKGROUND OF THE INVENTION

The prior art has put forth several designs for spare tire anti-theft mechanisms. Among these are:

U.S. Pat. No. 6,427,885 to Dennis D. Dexel describes a spare tire lock and lug wrench placement device designed to be attached to a motor vehicle or trailer.

U.S. Pat. No. 6,505,488 to William E. Princell describes a tire lock mounts to an opening in the vehicle frame in order to suspend a locking bar down through an opening in the spare wheel.

U.S. Pat. No. 6,749,094 to Dennis D. Dexel describes a lug wrench and spare tire locking assembly that is attached to a motor vehicle or trailer which includes a hollow wrench carrier body having four open-ended slots at right angles to each other that are configured to interface with a four-way lug-wrench.

None of these prior art references describe the present invention.

### SUMMARY OF THE INVENTION

It is an object of the present invention to provide an improved fifth-wheel towing hitch locking system.

### BRIEF DESCRIPTION OF THE DRAWINGS

FIG. 1 is a front perspective view of the device of the present invention.

FIG. 2 is a close-up perspective view of the device of the present invention installed in a trailer hitch.

FIG. 3 is an elevational view perspective of the device of the present invention installed in a trailer hitch in multiple locations.

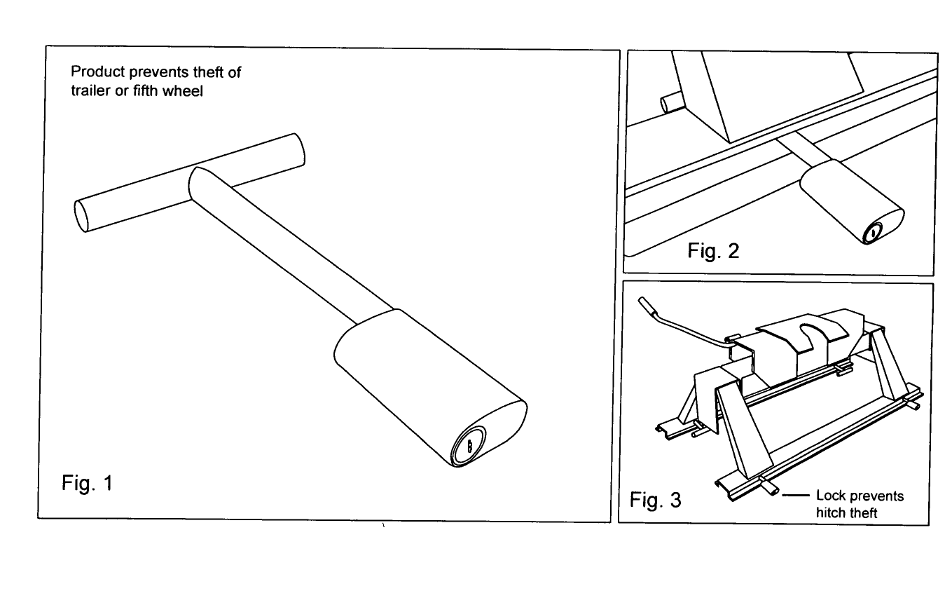

### DETAILED DESCRIPTION OF THE INVENTION

According to the Rough Guides travel book series, there are more than five million miles of paved highway. Approximately eight million families own and operate recreational vehicles, a home away from home to travel the highways and byways. One of the more popular trailers is the fifth-wheel trailer, which attaches to a towing vehicle with a king pin and coupler system similar to that used in tractor-trailer rigs. A pin or rod secures the king pin to the coupler, providing security for travel but this pin or rod does not lock, leaving the trailer vulnerable to theft. The present invention, hereinafter referred as Fifth Wheel Locking Pin, provides such a lock.

The Fifth Wheel Locking Pin is a pin fitted with a lock, providing security for the trailer. The device consists of a hardened steel bar one-half inch in diameter. The proximal end of the bar is a T-shaped handle made from the same stock, and the cross bar of the handle is any appropriate size, or approximately three inches in length, for example. The distal end of the bar is fitted with a lock. The end of the bar is machined to fit the lock, and the bar is grooved, enabling the lock to mate with the bar through pins that extend from the lock into the grooves. The bar is approximately four to seven inches in length. The lock is approximately two to three inches in length, one inch deep and two inches wide. The lock is mechanically operated by the turn of a key, extending or retracting the pins.

Use of the Fifth Wheel Locking Pin is simple and straightforward. The user follows the directions on how to disengage the king pin from the coupler. Then, once the vehicle is separated from the trailer, the Fifth Wheel Locking Pin is installed. The bar is slipped through the hole in the king pin and the lock is installed. With the bar secured on the king pin, the trailer cannot be hooked to a coupler until the bar is removed.

The Fifth Wheel Locking Pin, an anti-theft device designed for use with and built around the fifth-wheel towing hitch system, presents a number of distinct and significant benefits and advantages. Foremost, the Fifth Wheel Locking Pin provides a powerful anti-theft locking system for recreational vehicles utilizing the fifth-wheel hitch system. This security system provides the users of the Fifth Wheel Locking Pin peace of mind, knowing they had done everything possible to protect their trailer from theft. Most insurance companies offer discounts on coverage when the owner uses an anti-theft device on their vehicle.

The proximal, T-handle end of the 5th Wheel Locking Pin provides adequate surface area for the hand to develop maximum leverage when inserting or extracting the pin. Fabricated of high-quality, tool-grade steel, the Fifth Wheel Locking Pin resists rust and corrosion, and provides a long life of dependable, secure service.

A device made to secure recreational vehicles, the Fifth Wheel Locking Pin provides users with around the clock protection. Fabricated of tool-grade steel and industrial-strength locking components, the Fifth Wheel Locking Pin is virtually maintenance-free, and priced within the range of virtually all RV owners. Clearly, the Fifth Wheel Locking Pin has a wide and receptive market among fifth-wheel trailer owners.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A towing hitch locking system comprising:
a pin fitted with a lock, further comprising an elongate hardened steel bar wherein the proximal end of the bar terminates in a T-shaped handle made from the same stock, and wherein the distal end of the bar is fitted with a lock, wherein the end of the bar is fits the lock, and the bar is grooved, enabling the lock to mate with the bar through pins that extend from the lock into the grooves, and wherein the lock is mechanically operated by the turn of a key, extending or retracting the pins.

2. The towing hitch locking system of claim 1 wherein the towing hitch is configured for towing a fifth wheel trailer.

3. The towing hitch locking system of claim 1 wherein the T-shaped handle is approximately six inches in length.

4. The towing hitch locking system of claim 1 wherein the lock is approximately two to three inches in length, one inch deep and two inches wide.

5. The towing hitch locking system of claim 1 wherein the elongate hardened steel bar is half inch in diameter, and approximately four to seven inches in length.
